(19) United States
(12) Patent Application Publication
(10) Pub. No.: US 2005/0061128 A1
(43) Pub. Date: Mar. 24, 2005

(54) Saw guide apparatus

(76) Inventors: Patrick J. Caughlin, Flushing, MI (US); Raymone J. Schihl, Dryden, MI (US); Zenith W. Anson, Flint, MI (US)

Correspondence Address: JOHN MCCULLOCH, 5291 COLONY DRIVE NORTH, 1ST FLOOR, SAGINAW, MI, 48603, US

(21) Appl. No.: 10/665,706

(22) Filed: Sep. 19, 2003

(51) Int. Cl. B23D 45/02

(52) U.S. Cl. 83/574; 83/745

(57) ABSTRACT

Guide apparatus for guiding a tool such as a saw or router along a predetermined path relative to a workpiece has one or more track sections forming an elongate track parallel to the path to be followed by the tool. A tool-supporting carriage cooperates with the guide track so as to be guided by the track during movements of the tool. A stabilizer bar may be interlocked with the track in such manner as to prevent movement of the track laterally of the path along which the tool is to move.

This invention relates to saw guide apparatus and more particularly to apparatus which is especially adapted for use in guiding a circular saw or other tool along a selected path relative to a workpiece.

### BACKGROUND OF THE INVENTION

Circular saws are used conventionally for the cutting of relatively short workpieces, whereas table saws, rip saws, and panel saws are used for cutting larger workpieces. However, because the circular saw is compact, light weight, and easily transported and stored it is very much favored by carpenters at job sites.

One of the difficulties of using a circular saw for cutting longer workpieces, such as dimension board up to eight or more feet in length, is the difficulty in guiding the saw accurately as it is moved along the workpiece. This difficulty is magnified in those instances in which the workpiece to be cut is ten feet in length. However, such longer workpieces are encountered quite frequently.

An object of the invention is to provide a circular saw guide which overcomes or greatly minimizes the problems previously encountered when using a circular saw for cutting large workpieces.

### SUMMARY OF THE INVENTION

Guide apparatus constructed in accordance with the invention comprises one or more track-forming members which may be clamped to a workpiece that is to be cut so as to define the path of travel of the cutting tool relative to the workpiece. Each track-forming member has a T-slot therein which forms an internal chamber for the accommodation of a clamp, as well as couplings which connect adjacent track sections to one another. In a preferred embodiment a tool such as a circular saw is mounted on a carriage which may be movably supported on a workpiece and guided in its movements by the track. The track may be clamped to the workpiece so as to define a path to be traveled by the saw. The path should be a straight line from one end of the workpiece to the opposite end. The track can be so mounted that it is perpendicular to one end of the workpiece or extends obliquely thereto. The carriage includes a slide channel which embraces the guide track to ensure that the carriage follows the path defined by the track without skewing.

The track preferably is composed of multiple sections which may be coupled to one another in such manner as to form a track of such length as to span a workpiece having a length of up to eight or ten feet. The track forming members are clamped to the workpiece adjacent the ends of such members, thereby making it possible for the track to become laterally bowed between its ends in some instances. To overcome this undesirable characteristic apparatus according to the invention includes a stabilizing bar which may be coupled to a track-forming section in such manner as to prevent bowing of such section in either one of two opposite directions.

The carriage on which the saw is supported is of such length as to enable the carriage to be positioned on the workpiece at opposite ends of the latter in such manner as to ensure full support for the saw as it commences the cutting of the workpiece, as well as the finish of the cutting thereof, thereby minimizing the possibility of chipping or breaking the workpiece adjacent opposite ends of the cut. The track-forming sections and the stabilizer are constructed in such manner as to enable quick and reliable clamping and unclamping thereof to and from the workpiece so as greatly to facilitate the establishing of the path along which the saw travels.

### THE DRAWINGS

A preferred embodiment of the invention is illustrated in the accompanying drawings wherein:

FIG. 1 is an exploded, isometric view of guide apparatus constructed in accordance with the invention for use in guiding a circular saw along a predetermined path relative to a workpiece;

FIG. 2 is an enlarged, isometric view of a carriage for supporting the saw shown in FIG. 1;

FIG. 3 is a sectional view taken generally on the line 3-3 of FIG. 1;

FIG. 4 is a view similar to FIG. 1, but illustrating the parts in assembled relation with the saw and carriage moved longitudinally from the positions shown in FIG. 1;

FIG. 5 is a fragmentary, isometric view illustrating the coupling of two track-forming sections to one another;

FIG. 6 is a greatly enlarged sectional view taken along the line 6-6 of FIG. 4; and

FIGS. 7 and 8 are sectional views illustrating the clamping and unclamping of a stabilizing bar to the track.

### THE PREFERRED EMBODIMENT

Apparatus constructed in accordance with the preferred embodiment of the invention is adapted for use in conjunction with a conventional circular saw 1 having a base 2 on which a supporting frame 3 is secured. The saw has a driving motor 4 which drives a rotary blade 5. The saw also has a handle 6 and a guard 7, all of which are conventional.

The circular saw is adapted to have its base 2 removably secured atop a carriage 8 comprising a slide plate 9 terminating at one edge in a guide slide 10 having a top 11 and spaced apart sides 12 and 13 which, together, form a channel 14. The side 12 abuts a mounting member 15 having a T-shaped slot 16 therein, the member 15 being secured to the plate 9. A similar mounting member 17 is secured to one end of the mounting plate 9 and has a similar T-slot 18 therein.

The base 2 of the saw 1 is adapted to be placed atop the slide plate 9 and secured thereto by clamps 19, each of which has a strap 20 which overlies the associated mounting member 15, 17, a downwardly turned flange 21, and a foot 22 that is adapted to seat upon the upper surface of the saw base 2. Bolts 23 are accommodated in the T-shaped slot of the mounting member and extend through slots 24 in the strap 20. The bolts receive threaded fasteners 25 by means of which the clamps 19 may be forced downwardly so that their feet 22 bear firmly on the upper surface of the saw base 2 and secure the saw to the carriage.

The illustrated saw 1 comprises a portable, circular saw of conventional construction and of such capacity as to cut a workpiece W such as a sheet of dimension material which may be plywood, sheet rock, particle board, or the like.

Preparatory to sawing a workpiece W it is necessary to define a path along which the saw 1 may be moved. According to the invention this is accomplished by the provision of a track 26 composed of one or more track sections 27, 28, and 29, depending upon the length of the track which is to be formed.

Each track-forming section comprises an elongate member forming a housing 30 having a chamber therein. The housing in each case comprises a top wall 31, substantially parallel side walls 32, and a bottom wall 33 having a longitudinally extending, centrally located slot 34 therein providing access to the chamber of the housing 30. Preparatory to sawing the workpiece W one or more of the track-forming sections are placed upon the workpiece W with the slot 34 confronting the upper surface of the workpiece. A cut line 35 is drawn on the workpiece where the workpiece is to be cut by the saw.

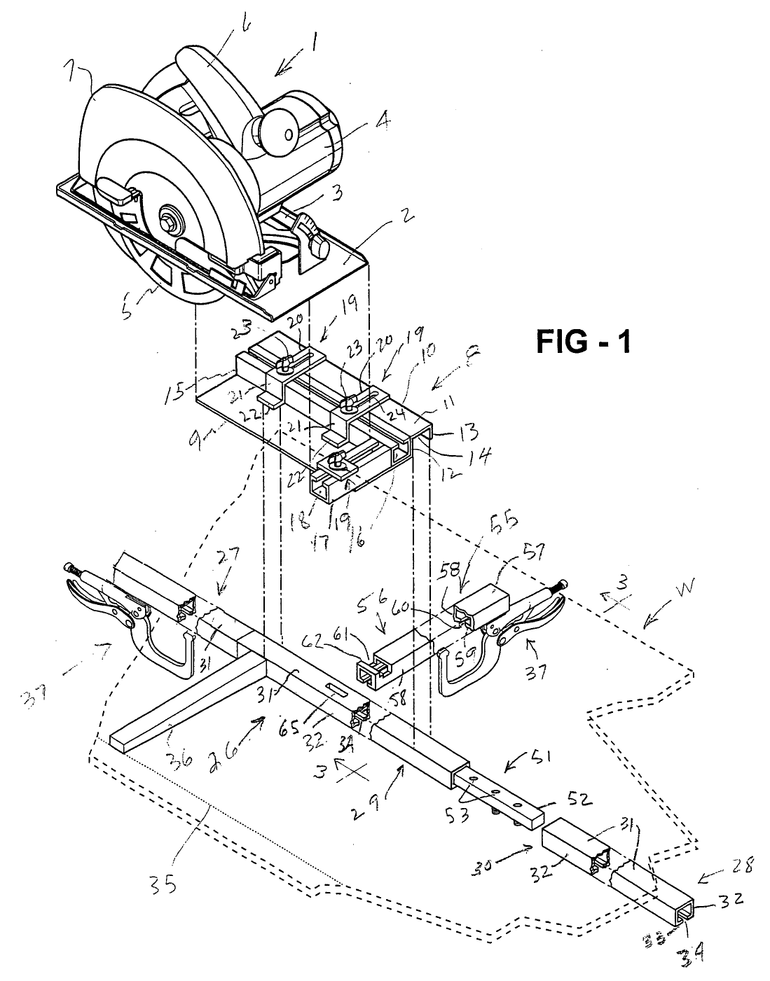

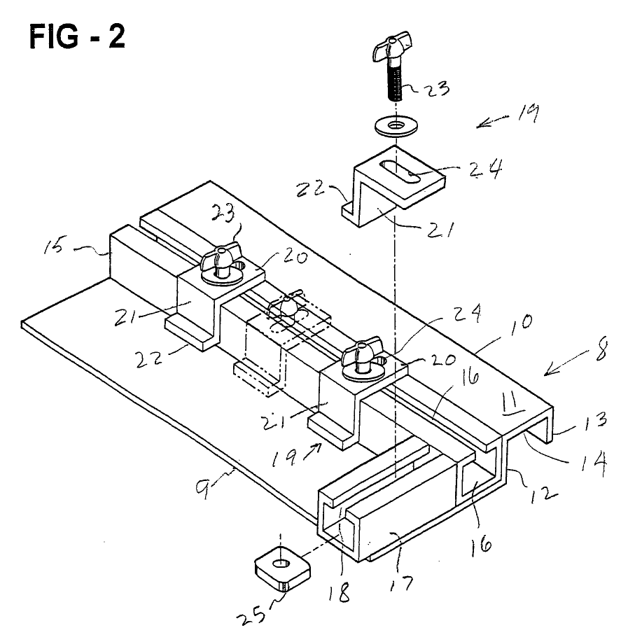

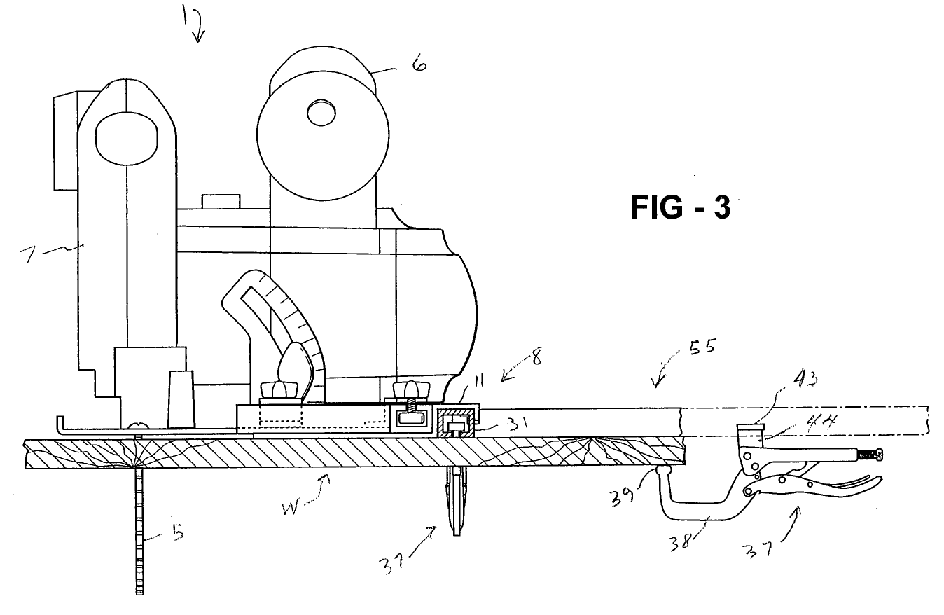

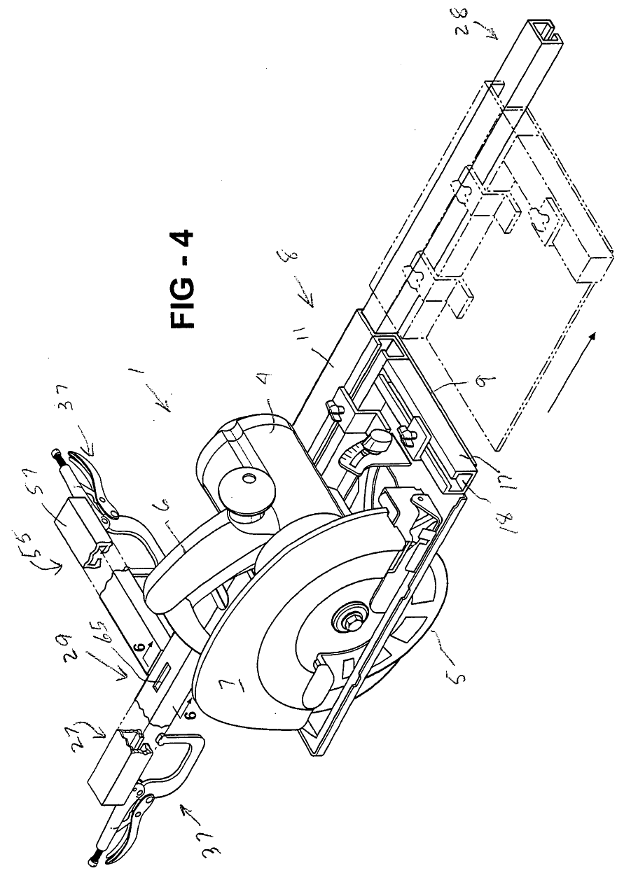

To facilitate positioning of the track the proper distance from the saw line 35, a gage 36 of predetermined length may be placed with one end flush with the saw line 35 and the other end abutting one of the track-forming sections. As shown in FIG. 1, the gage abuts the wall 32 of the section 29. A clamp 37 (to be described in more detail subsequently) then is used to clamp the section 29 to the workpiece.

The gage 36 is free to move, so it may be moved to the opposite end of the track-forming section which overlies the opposite end of the workpiece. Another clamp like the clamp 37 then may be used to clamp the opposite end of the track 26 to the workpiece W.

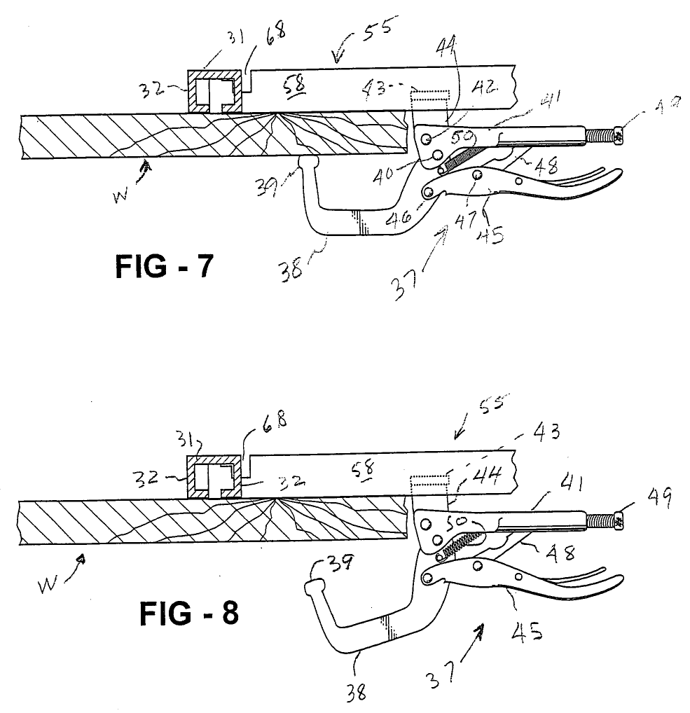

A clamp 37 of the kind well suited for use with the track 26 is best shown in FIGS. 7 and 8 and comprises a frame 38 terminating at one end in a rounded jaw 39 that is adapted to bear against the bottom surface of the workpiece W. At the opposite end of the frame is pivoted at 40 an arm 41 which also is coupled as at 42 to a jaw 43 at the free end of a support stem 44 which is coupled to the arm 41. The support stem 44 is of such width as freely to slide through the slot 34 in each of the track-forming members, but the width of the jaw 43 is such as to enable it to bear firmly on the inner surface of the wall 31 on opposite sides of the slot 34. An operating lever 45 is pivoted at 46 to the frame 38 and at 47 to one end of an adjusting link 48, the opposite end of which bears against an adjusting screw 49. An over centering spring 50 is pivoted at its opposite ends to the frame 38 and to an anchor point (not shown) on the arm 41. Except for the jaws 39 and 43 and the stem 44 the clamp 37 corresponds to an adjustable clamp sold extensively under the trademark VICE GRIP.

When clamping the ends of the track formed by one of more of the track-forming sections 27, 28, and 29 one edge of the track will be placed along the cut line 35 so that the track extends parallel to the path to be followed by the saw as it is moved along the workpiece.

In using the clamp 37 the frame 38 is moved to its jaw-opening position as shown in FIG. 8 so as to be well spaced below the bottom of the workpiece W. The jaw 43 then may be aligned with the chamber in the housing 30 and the support 44 inserted in the slot 34, thereby enabling the clamp to be slid longitudinally of the track-forming member until the clamp is in a position to clamp the track-forming member to the upper surface of the workpiece, whereupon the actuating lever may be adjusted to cause the jaw 39 to bear firmly against the lower surface of the workpiece and the jaw 43 to bear firmly against the inner surface of the wall 33 on opposite sides of the slot 34.

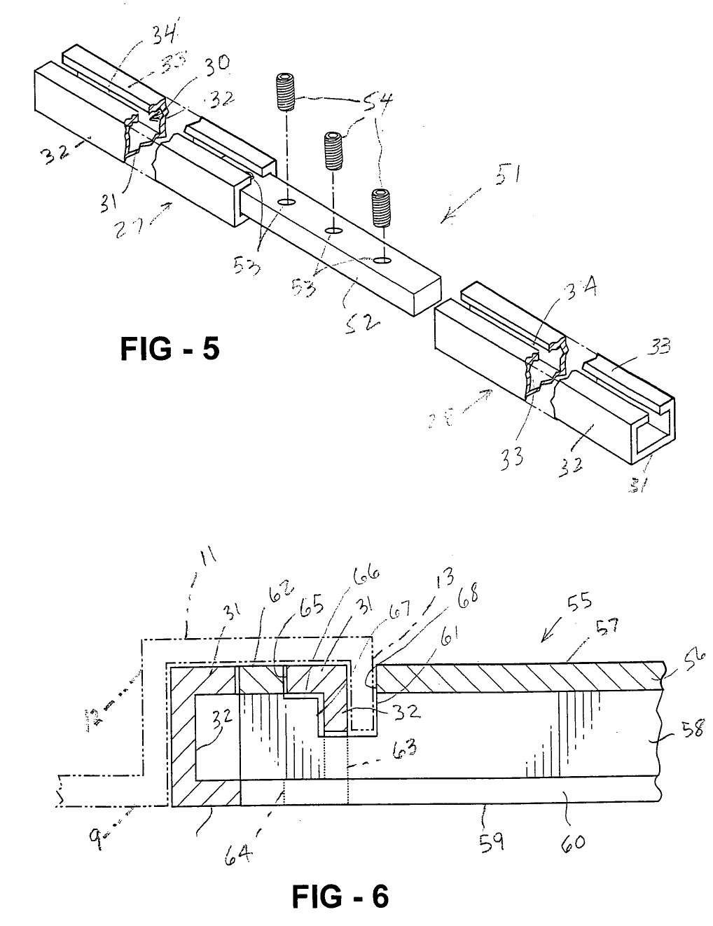

In some instances a single track-forming member 27 or 28 may be sufficient in length. In other instances, however, a longer track may be desirable. In this event two track sections 27 and 28 may be coupled to one another by means of a coupling 51 best shown in FIG. 5.

The coupling comprises a connecting body or bar 52 corresponding in size and shape to the chamber formed by the housing 30 of each such section. The connector 52 is of such length as to extend well beyond the joint between the two abutting ends of two adjacent sections 27 and 28 so as to provide stability. The bar 52 has a plurality of threaded openings 53 therein each of which is adapted to accommodate a force applying anchor, such as a threaded set screw 54, three of which are shown in FIG. 5. Each set screw is of such size as to pass through the slot 34 of any one of the track-forming members so as to bear against the upper wall 31 thereof and react with the latter to cause the bar 52 to seat firmly on the bottom wall 33 on opposite sides of the slot 34. When the confronting ends of two adjacent track-forming sections abut one another and the set screws are fully seated, a secure and removable coupling of the two track-forming sections to one another is obtained.

Depending upon the length of the track-forming sections and how many of them are required to produce a track of appropriate length, there may be a tendency on the part of the track to become bowed in one direction or the other between its ends. To overcome this tendency and thereby to stabilize the track a stabilizing member 55 is provided.

The stabilizing member 55 is best shown in FIGS. 1 and 6-8 and comprises a channel or bar 56 like the sections 27, 29 in that it has a top wall 57, parallel side walls 58, and a bottom wall 59 in which is a longitudinally extending slot 60 corresponding in all respects to the track sections 27, 28.

At one end of the member 55 the top and side walls 57, 58 are cut away to form a notch 61. The notch does not extend completely to the adjacent end of the member 55, but terminates short thereof so as to form an upstanding latch or tongue 62.

The stabilizing member 55 is adapted to cooperate with the track-forming section 29. For this purpose one side wall 32 of the section 29 is cut to provide a socket 63 and the bottom wall 59 of the member 55 is transversely slotted as at 64. The top wall 31 of the section 29 is provided with a longitudinally extending slot 65 of such size as snugly to accommodate the tongue 62. The construction and arrangement are such that the end of the stabilizing member 55 bearing the tongue 62 may be accommodated in the socket 63 and 64 with the tongue 62 accommodated in the slot 65. That edge of the notch 61 which is adjacent the tongue 62 is provided with a step 66 which underlies the top wall 31 of the track-forming section 29 and a shoulder 67 which abuts the inner surface of the side wall 32 of the section 29. The construction inhibits movement of the stabilizing bar inward, outward, and longitudinally relative to the track. The tongue 62 therefore constitutes, in effect, a latch. FIG. 6 exaggerates for clarity the clearances between the confronting surfaces of the interlocking parts of the track section 29 and the stabilizing member 55.

As is clearly shown in FIG. 6 the notch 61 and the socket 63 in the top and side walls of the stabilizing member 55 provide a channel 68 through which the flange 13 of the carriage 8 may pass. Again, the clearances between the flange 13 and the edges of the notch 61 are exaggerated for purposes of clarity.

To condition the apparatus for operation, and assuming the workpiece W to be cut is a dimension board 4×8 feet in width and length, respectively, the saw 1 is secured to the carriage 8 by applying the base 2 to the carriage plate 9 and clamping the base to the carriage plate 9 by clamps 19.

The track 26 formed by the track members 27-29 may be placed atop the workpiece W and one end of the track clamped lightly by a clamp 37 to the workpiece. The opposite end of the track may be lightly clamped to the workpiece by the use of another clamp 37. The gage 36 then may be used to position the opposite ends of the track parallel to the cut line 35 a precise distance from the latter, following which the clamps 37 may be adjusted so as to provide secure clamping forces on the opposite ends of the track.

If more than one track-forming section is required because of the size of the workpiece, two or more sections may be coupled in prolongation of one another by utilizing the coupling member 51.

When using two or more of the track-forming sections it may be desirable to make use of the stabilizing member 55. If so, and if the track sections 27 and 28 do not include the coupling socket 63 or the slot 65, the track section 29 may be coupled at its opposite ends to the track sections 27 and 28 by using the coupling means 51. That end of the bar 56 adjacent the track 26 may be fitted into the socket 63 so as to become interlocked with the track-forming section. That end of the stabilizing bar 56 which is remote from the track 26 may be clamped atop the workpiece W by another clamp 37.

The interlocking connection of the stabilizing bar with the track-forming section performs two important functions: first, the fitting of the tongue 62 in the slot 65 prevents relative movement of the track laterally of the workpiece, thereby avoiding bowing of the track between its ends. Second, the fitting of the tongue 62 in the slot 65 and the interengagement of the shoulder 67 with the wall 32 of the track-forming section ensures the maintenance of the channel 68 through which the flange 13 of the saw-supporting carriage may pass without interference in response to movement of the saw longitudinally along the path defined by the track.

Following assembly of the appropriate number of track-forming sections and the stabilizing bar, if necessary, the saw and its supporting carriage 8 may be placed atop the workpiece so that the channel formed by the walls 11, 12, and 13 embrace the end track-forming section. Because of the use of the gage 36 the sawblade 5 will be located in such position relative to the workpiece as to be aligned with the cut line 35.

The carriage 8 projects sufficiently far forward of the saw that the forward end of the carriage may be supported by the workpiece even though the sawblade itself does not engage the workpiece in the initial position of the carriage relative to the track. This feature facilitates the assembly of the saw carriage and the track.

Once the carriage has been assembled with the track the drive motor 4 may be energized so as to rotate the sawblade, following which the carriage may be moved along the workpiece and be guided by the track from one end of the workpiece to the other, thereby cutting the workpiece along the cut line 35.

The length of the carriage 8 also is such that the saw will be supported on the workpiece by the carriage following movement of the carriage to a position in which the sawblade is beyond the edge of the workpiece. This feature eliminates the possibility of having an errant chip cut from the workpiece.

The track-forming sections 27 and 28 preferably are four feet in length, whereas the track-forming section 29 is two feet in length. When the three sections are coupled to one another, therefore, they form a track ten feet in length which usually is the maximum length of dimension boards. The stabilizing bar 55 preferably is four feet in length, thereby enabling it to be used with dimension materials as well.

The provision of multiple, separable sections of track-forming members enables the various sections to be disassembled for compact transport and storage.

Although the description has emphasized the apparatus for use in conjunction with a circular saw, it will be understood by those skilled in the art that the apparatus may be used equally well with other tools, such as a router for example.

The disclosed embodiment is representative of the preferred form of the invention, but is intended to be illustrative rather than definitive thereof. The invention is defined in the claims.

1. Guide apparatus for guiding a tool along a path relative to a workpiece, said apparatus comprising a guide track; clamp means for releasably clamping said track to one side of such workpiece whereby said track defines a path to be followed by such tool; a carriage for supporting such tool and adapted to be supported by said workpiece for reciprocable movement relative thereto along said path; and slideable guide means carried by said carriage and slideably cooperating with said track for guiding such tool along said path in response to movements of said carriage.

2. The apparatus according to claim 1 wherein said track is composed of multiple sections, and including coupling means for separably coupling said sections to one another in prolongation of each other.

3. The apparatus according to claim 2 wherein each of said sections comprise an elongate member forming a housing having a chamber therein, said coupling means comprising an elongate connector removably accommodated in the chamber of each of two abutting ones of said sections, and securing means releasably securing said connector to each of said adjacent ones of said sections.

4. The apparatus according to claim 3 wherein each of said sections has a plurality of walls forming said chamber, one of said walls having an elongate slot therein through which said securing means extends.

5. The apparatus according to claim 1 wherein said track comprises an elongate member having walls defining a chamber, one of said walls having a slot therein extending longitudinally of said member.

6. The apparatus according to claim 1 wherein said track comprises an elongate member having walls defining a chamber and wherein said clamp means comprises a frame having a pair of relatively movable jaws, one of said jaws being of such size as to be accommodated in said chamber and the other of said jaws being engageable with said workpiece on that side of the latter opposite said one side, and actuating means coupled to said jaws for moving said jaws relatively toward and away one another for releasably clamping and unclamping said track to and from said workpiece.

7. The apparatus according to claim 1 wherein said track has walls defining a chamber enclosed by said walls, one of said walls having a socket therein in communication with said chamber, and including elongate stabilizing means having at one end thereof a projection extending through said socket into said chamber, said projection and said socket being so configured that when said projection is accommodated in said socket said projection inhibits movements of said stabilizing means inward and outward of said socket.

8. The apparatus according to claim 7 wherein said projection extends in prolongation of said stabilizing means and includes an upstanding latch which removably may be accommodated in a slot formed in another of said walls of said track.

9. The apparatus according to claim 7 wherein said stabilizing means has a channel therein adjacent said track through which said retaining flange may pass as said carriage is moved longitudinally of said track.

10. Guide apparatus for guiding a tool along a path relative to a workpiece, said apparatus comprising an elongate track having walls defining an internal chamber; clamp means at opposite ends of said track for releasably clamping said track to a workpiece in such manner that such track overlies one surface of said workpiece and defines a path; a carriage for supporting such tool and adapted to be supported on said one surface of such workpiece; slide means for slideably coupling said carriage to said track for reciprocable movements along said path; stabilizing means for minimizing movement of said track transversely of said path; and connecting means removably connecting said stabilizing means to said track and to such workpiece.

11. The apparatus according to claim 10 wherein said connecting means comprises a projection carried by said stabilizing means for insertion into said chamber through a notch in a wall of said track, said projection when accommodated in said chamber being operable to inhibit movement of said stabilizing means transversely of said track.

12. The apparatus according to claim 10 wherein said stabilizing means has a channel adjacent said projection through which said guide flange of said carriage may pass.

13. The apparatus according to claim 10 wherein one wall of said track has a slot extending longitudinally of said track and in communication with said chamber and wherein said clamp means includes a pair of jaws, means for moving said jaws toward and away from one another, one of said jaws being of such size and shape as to be accommodated in said chamber, said one of said jaws being supported by a stem of such size as slideably to be accommodated in said slot.

14. The apparatus according to claim 13 wherein said track is composed of multiple sections extending in prolongation of one another, and including coupling means for coupling two adjacent ones of said sections together.

15. The apparatus according to claim 14 wherein said coupling means comprises an elongate body a part of which is accommodated in the chamber of one of said sections and the remainder of said body is accommodated in the chamber of the adjacent section.

16. The apparatus according to claim 15 including anchor means for anchoring said body in the respective chambers of said adjacent sections.

17. The apparatus according to claim 16 wherein said anchor means comprises a first force applying member carried by said body and bearing on one of said sections and a second force applied member carried by said body and bearing on the adjacent section.

18. The apparatus according to claim 17 wherein said force applying members are accessible via the slot in the associated track section.

19. Guide apparatus for guiding a circular saw along a path relative to a workpiece, said saw having a rotary sawblade supported on a frame, said apparatus comprising a carriage; means removably mounting the frame of said saw on said carriage; an elongate track having walls defining a chamber, one of said walls having a slot in communication with said chamber and extending longitudinally of said track; clamp means at opposite ends of said track removably clamping said track to said workpiece, whereby said track sections define said path, each said clamp means having a pair of jaws movable toward and away from one another, one of the jaws of said pair being accommodated in said track and the other of said jaws of said pair being against said workpiece and together with said one of said jaws clamping said workpiece and said track to one another; and a guide channel on said carriage and slideably embracing said track for guiding said carriage along the path defined by said track.

20. The apparatus according to claim 19 wherein said track has a socket in one of said walls in communication with said chamber and a slot in another of said walls in communication with said chamber, a stabilizing bar having a projection at one end terminating in a tongue, said projection extending into said chamber via said socket and said tongue being accommodated in said slot in interlocking relation with said track.
